(19) United States
(12) Patent Application Publication
(10) Pub. No.: US 2024/0070006 A1
(43) Pub. Date: Feb. 29, 2024

(54) MEMORY SYSTEM AND METHOD OF CONTROLLING NONVOLATILE MEMORY

(71) Applicant: Kioxia Corporation, Tokyo (JP)

(72) Inventors: Shinichi KANNO, Ota (JP); Yuki SASAKI, Kamakura (JP)

(73) Assignee: Kioxia Corporation, Tokyo (JP)

(21) Appl. No.: 18/180,234

(22) Filed: Mar. 8, 2023

(30) Foreign Application Priority Data
Aug. 30, 2022 (JP) 2022-136954

(51) Int. Cl. G06F 11/07; G06F 11/14

(52) U.S. Cl. CPC G06F 11/0772; G06F 11/076; G06F 11/1489

(57) ABSTRACT

According to one embodiment, when a code rate is less than 1, a controller encodes a plurality of pieces of write data to generate a codeword including the plurality of pieces of write data and one or more erasure recovery codes. The controller calculates a cumulative error count. The controller calculates at least one of a cumulative write amount or a cumulative read amount. The controller change the code rate such that the code rate is increased when a first value which is obtained by dividing the cumulative error count by the cumulative write amount or the cumulative read amount is less than a first threshold value, and the code rate is decreased when the first value is larger than or equal to a second threshold value.

### CROSS-REFERENCE TO RELATED APPLICATIONS

This application is based upon and claims the benefit of priority from Japanese Patent Application No. 2022-136954, filed Aug. 30, 2022, the entire contents of which are incorporated herein by reference.

### FIELD

Embodiments described herein relate generally to a technology of controlling a nonvolatile memory.

### BACKGROUND

Memory systems implemented with a nonvolatile memory have recently become widespread. As such memory systems, a solid state drive (SSD) implemented with a NAND flash memory has been known.

In the memory system such as the SSD, an erasure recovery technology may be used to maintain the reliability of the memory system. The erasure recovery technology is a technology of recovering lost data using an erasure recovery code.

However, the number of times data loss occurs in the memory system may vary as time elapses. For this reason, when erasure recovery encoding having a capability of constant erasure recovery is always used, the erasure recovery codes written to a nonvolatile memory may be wasted without being used during a period when the amount of lost data is small. Writing useless erasure recovery codes to a nonvolatile memory increases the write amplification of the memory system, resulting in degradation in the write performance of the memory system and reduction in the memory system lifetime.

For this reason, a new technique that can improve write amplification while maintaining the reliability is required for the memory systems.

### BRIEF DESCRIPTION OF THE DRAWINGS

FIG. 1 is a block diagram illustrating a configuration example of an information processing system that includes a memory system according to an embodiment.

FIG. 2 is a block diagram illustrating an example of a relationship between a plurality of channels and a plurality of NAND flash memory dies, which are used in the memory system according to the embodiment.

FIG. 3 is a diagram illustrating a configuration example of a super block used in the memory system according to the embodiment.

FIG. 4 is a diagram illustrating a first example of a super block to which data is written at a first code rate in the memory system according to the embodiment.

FIG. 5 is a diagram illustrating a second example of a super block to which data is written at a second code rate in the memory system according to the embodiment.

FIG. 6 is a diagram illustrating a third example of a super block to which data is written at a third code rate in the memory system according to the embodiment.

FIG. 7 is a diagram illustrating a fourth example of a super block to which data is written at a fourth code rate in the memory system according to the embodiment.

FIG. 8 is a diagram illustrating a fifth example of a super block to which data is written at a fifth code rate in the memory system according to the embodiment.

FIG. 9 is a diagram illustrating a codeword generated based on the first code rate in the memory system according to the embodiment.

FIG. 10 is a diagram illustrating the number of internal errors and the number of data errors in the memory system according to the embodiment.

FIG. 11 is a diagram illustrating code rate information used in the memory system according to the embodiment.

FIG. 12 is a diagram illustrating an example of a data write process and a data read process executed in the memory system according to the embodiment.

FIG. 13 is a flowchart illustrating a procedure of a code rate change process executed in the memory system according to the embodiment.

FIG. 14 is a flowchart illustrating a procedure of the data write process executed in the memory system according to the embodiment.

FIG. 15 is a flowchart illustrating a procedure of the data read process executed in the memory system according to the embodiment.

FIG. 16 is a flowchart illustrating a second procedure of the code rate change process executed in the memory system according to the embodiment.

### DETAILED DESCRIPTION

Various embodiments will be described hereinafter with reference to the accompanying drawings.

In general, according to one embodiment, a memory system is connectable to a host. The memory system comprises a nonvolatile memory and a controller configured to generate a codeword including a plurality of pieces of write data received from the host and to write the codeword to the nonvolatile memory. When a code rate is less than 1, the controller encodes, based on the code rate, the plurality of pieces of write data to generate the codeword including the plurality of pieces of write data and one or more erasure recovery codes. When the code rate is 1, the controller generates the codeword including the plurality of pieces of write data and not including an erasure recovery code. The controller calculates a cumulative error count indicative of a cumulative value of the number of times a data error occurs. The data error is an error that fails to return correct data to the host. The controller calculates at least one of a cumulative write amount or a cumulative read amount. The cumulative write amount is indicative of a total amount of write data written to the nonvolatile memory based on write commands received from the host. The cumulative read amount is indicative of a total amount of read data required to be read from the nonvolatile memory by read commands received from the host. The controller changes the code rate based on a first value which is obtained by dividing the cumulative error count by the cumulative write amount or the cumulative read amount, such that the code rate is increased when the first value is less than a first threshold value, and the code rate is decreased when the first value is larger than or equal to a second threshold value larger than or equal to the first threshold value. When the code rate is changed, the controller encodes new write data received from the host, and data to be copied from a copy source memory location to a copy destination memory location in the nonvolatile memory, using the changed code rate.

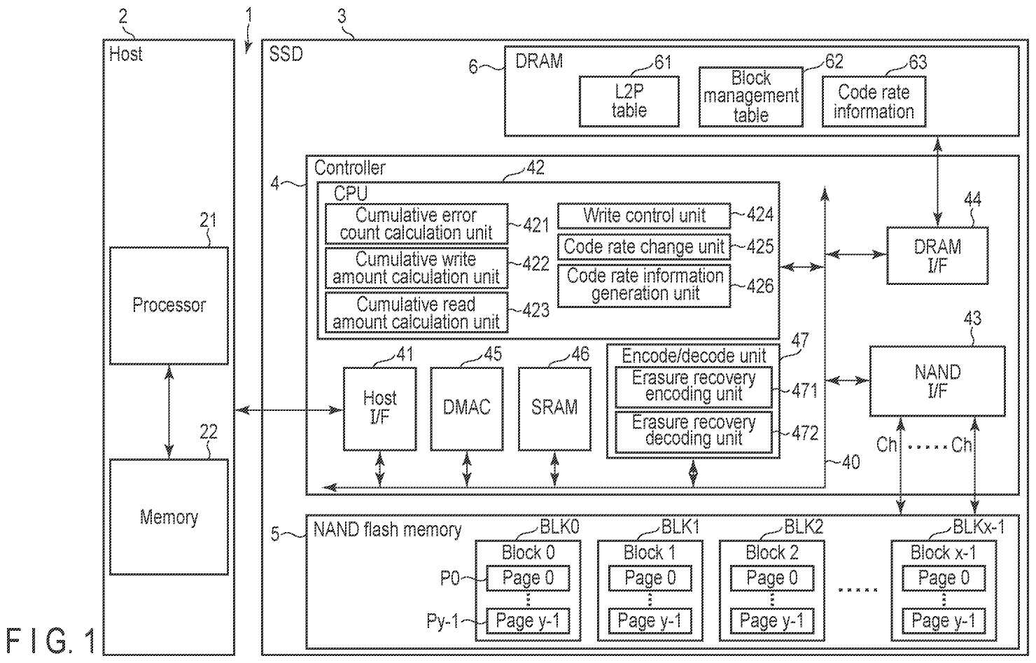

First, a configuration of an information processing system that includes a memory system according to the embodiment will be described. FIG. 1 is a block diagram illustrating a configuration example of the information processing system that includes the memory system according to the embodiment and a host. In the following descriptions, the memory system according to the embodiment is assumed to be implemented as a solid state drive (SSD).

An information processing system 1 includes a host (host device) 2 and a SSD 3.

The host 2 is an information processing apparatus configured to access the SSD 3. Examples of the information processing apparatuses include personal computers, server computers, and various other computing devices. Host 2 transmits a write request (write command), which is a request to write data, to the SSD 3. In addition, the host 2 also transmits a read request (read command), which is a request to read data, to the SSD 3.

The SSD 3 is a semiconductor storage device configured to write data to a nonvolatile memory and to read data from a nonvolatile memory. For example, a NAND flash memory is used as the nonvolatile memory. The SSD 3 executes a data write operation based on a write command received from the host 2. In addition, the SSD 3 executes a data read operation based on a read command received from the host 2.

For example, Serial Attached SCSI (SAS), Serial ATA (SATA), or NVM Express™ (NVMe™) is used as a standard of a logical interface for connecting the host 2 and the SSD 3.

Next, constituent elements of the host 2 will be described. The host 2 includes a processor 21 and a memory 22.

The processor 21 is a central processing unit (CPU). The processor 21 is configured to control operations of each component of the host 2. The processor 21 executes software (host software) that is loaded from the SSD 3 into the memory 22. The host 2 may include another storage device other than the SSD 3. In this case, the host software may be loaded into the memory 22 from said another storage device. The host software includes an operating system, file systems, device drivers, application programs, and the like.

The memory 22 is the main memory provided in the host 2. The memory 22 is a volatile semiconductor memory. The memory 22 is implemented by, for example, a random access memory such as a dynamic random access memory (DRAM).

Next, components of the SSD 3 will be described. The SSD 3 includes a controller 4, a NAND flash memory 5, and a DRAM 6.

The controller 4 is electrically connected to the NAND flash memory 5 which is a nonvolatile memory via a NAND interface 43 such as Toggle NAND flash interface or Open NAND Flash Interface (ONFI). The controller 4 operates as a memory controller configured to control the NAND flash memory 5. The controller 4 may be implemented by a circuit such as a System-on-a-chip (SoC).

The NAND flash memory 5 includes a memory cell array including a plurality of memory cells arranged in a matrix. The NAND flash memory 5 may be a flash memory having a two-dimensional structure or a flash memory having a three-dimensional structure.

The memory cell array of the NAND flash memory 5 includes a plurality of blocks BLK0 to BLKx−1. Each of the blocks BLK0 to BLKx−1 includes a plurality of pages (in this example, pages P0 to Py−1). Each of the blocks BLK0 to BLKx−1 functions as a unit for a data erase operation. The blocks may be referred to as “erase blocks”, “physical blocks” or “flash blocks”. Each of the pages P0 to Py−1 is a unit for a data write operation and a data read operation.

The DRAM 6 is a volatile semiconductor memory. The DRAM 6 is used, for example, for temporarily storing data to be written to the NAND flash memory 5. In addition, a storage area of the DRAM 6 is used to store various management data used by the controller 4.

Next, a detailed configuration of the controller 4 will be described.

The controller 4 includes a host interface (I/F) 41, a CPU 42, a NAND interface (I/F) 43, a DRAM interface (I/F) 44, a direct memory access controller (DMAC) 45, a static RAM (SRAM) 46, and an encode/decode unit 47. The host interface 41, the CPU 42, the NAND interface 43, the DRAM interface 44, the DMAC 45, the SRAM 46, and the encode/decode unit 47 are interconnected via a bus 40.

The host interface 41 is a host interface circuit configured to execute communication with the host 2. The host interface 41 is, for example, a PCIe controller. Alternatively, when the SSD 3 is configured to incorporate a network interface controller, the host interface 41 may be implemented as part of the network interface controller. The host interface 41 receives various commands from the host 2. These commands include a write command, a read command, a copy command, and the like.

The CPU 42 is a processor. The CPU 42 controls the host interface 41, the NAND interface 43, the DRAM interface 44, the DMAC 45, the SRAM 46, and the encode/decode unit 47. The CPU 42 loads a control program (firmware) from the NAND flash memory 5 or ROM (not shown) to the DRAM 6 or the SRAM 46, in response to the supply of power to the SSD 3.

The NAND interface 43 is a memory interface circuit that controls the NAND flash memory 5. The NAND interface 43 controls the NAND flash memory 5 under control of the CPU 42. When the NAND flash memory 5 includes a plurality of NAND flash memory dies, the NAND interface 43 may be connected to the plurality of NAND flash memory dies via a plurality of channels (Ch). The communication between the NAND interface 43 and the NAND flash memory 5 is executed in conformity with, for example, Toggle NAND flash interface or open NAND flash interface (ONFI).

The DRAM interface 44 is a DRAM interface circuit that controls the DRAM 6. The DRAM interface 44 controls the DRAM 6 under control of the CPU 42.

The DMAC 15 is a circuit that executes direct memory access (DMA). The DMAC 15 executes data transfer between the memory 22 of the host 2 and the DRAM 6 (or the SRAM 46) under control of the CPU 42. When write data is to be transferred from the memory 22 of the host 2 to the DRAM 6 (or the SRAM 46), the CPU 42 specifies a source address indicating a location in the memory 22 of the host 2 where the write data is stored, the size of the write data, and a destination address indicating a location in the DRAM 6 (or the SRAM 46) to which the write data is to be transferred, for the DMAC 45.

The SRAM 46 is a volatile memory. The SRAM 46 is used as, for example, a work area of the CPU 42.

When data is to be written to the NAND flash memory 5, the encode/decode unit 47 executes encoding to add an error correction code (ECC) to this data as a redundant code. When data is read from the NAND flash memory 5, the encode/decode unit 47 executes decoding for error correction of the read data, using the ECC added to the read data. Failure of error correction in decoding using the ECC is referred to as an ECC error. In addition, the encode/decode unit 47 includes an erasure recovery encoding unit 471 and an erasure recovery decoding unit 472.

The eraser recovery encoding unit 471 generates a codeword by executing eraser recovery encoding for a plurality of pieces of data to be written to the NAND flash memory 5. For example, Reed-Solomon code, parity check code, or, the like is used as a code for erasure recovery encoding (erasure recovery code). The codeword is a systematic code that includes a plurality of information symbols and one or more redundant symbols. A rate of the information symbols to a plurality of symbols included in a codeword is referred to as a code rate. For example, when the total number of information symbols and redundant symbols included in a codeword is referred to as n and the number of information symbols is referred to as k, the code rate of this codeword is expressed as k/n. The erasure recovery decoding unit 472 determines the number of redundant symbols to be included in a codeword based on code rate, and generates the codeword. The maximum value of the code rate is 1. When the code rate is 1, the codeword includes only information symbols and does not include a redundant symbol. Therefore, the codeword generated by the erasure recovery encoding unit 471 includes a plurality of information symbols and zero or more redundant symbols. The plurality of information symbols are, for example, a plurality of pieces of write data. The one or more redundant symbols are, for example, one or more erasure recovery code which are redundant codes generated by encoding the plurality of pieces of write data. The codeword generated by the erasure recovery encoding unit 471 is, for example, written across a plurality of blocks. In this case, the plurality of pieces of write data and the one or more erasure recovery codes included in the codeword are written to blocks different from each other.

The erasure recovery decoding unit 472 executes the erasure recovery process when error correction for data read from the NAND flash memory 5 is failed, i.e., when loss of data is detected. The erasure recovery decoding unit 472 determines whether or not the codeword containing the lost data includes an erasure recovery code. When this codeword includes an erasure recovery code, the erasure recovery decoding unit 472 executes the erasure recovery process for this codeword. In the erasure recovery process, the erasure recovery decoding unit 472 reads (i) pieces of remaining data included in this codeword, excluding the lost data, and (ii) the one or more redundant codes included in this codeword from the NAND flash memory 5, and recovers the lost data using the pieces of remaining data and the redundant codes. An amount of lost data that can be recovered by the codeword is the same as the amount of the erasure recovery codes included in the code word as redundant codes. A plurality of pieces of write data and the one or more erasure recovery codes included in the codeword are written to blocks different from each other, respectively. For this reason, even if data written in one block cannot be read correctly, this data can be recovered using the pieces of data of other blocks and the one or more erasure recovery codes of still other blocks different from these other blocks.

Next, the information stored in the DRAM 6 will be described. The DRAM 6 stores a logical-to-physical address translation table (L2P table) 61, a block management table 62, and code rate information 63.

The L2P table 61 is a table that stores mapping information. The mapping information is information indicative of the correspondence between each of logical addresses and each of physical addresses. The logical address is an address that identifies data to be accessed. The logical address is specified by a command (write command, read command, or the like) from the host 2. A logical block address (LBA) is used as the logical address. One LBA corresponds to, for example, data of one sector (for example, 4 KiB). The physical address is an address that specifies the physical storage location of the NAND flash memory 5. The physical address includes, for example, a block address and an in-block offset. The block address is an address that can uniquely identify an individual block. When the NAND flash memory 5 includes a plurality of NAND flash dies, the block address of a certain block may be represented by a die number indicative of a NAND flash die among the plurality of NAND flash dies and a block number indicative of a block among a plurality of blocks within this NAND flash die. The in-block offset is an offset address that can uniquely identify each of memory locations included in a block. The offset address at a particular memory location in a block may be represented by the number of sectors from the starting memory location in the block to the particular memory location.

The block management table 62 is used to store management information for managing each of the plurality of blocks of the NAND flash memory 5.

The block management table 62 is a table that includes management information corresponding to blocks included in the memory system 3. The management information managed by the block management table 62 includes, for example, information indicative of the erase count (number of program/erase cycles) of the corresponding block and information indicative of whether the corresponding block is available or not.

The code rate information 63 is information corresponding to each of the codewords written to the NAND flash memory 5. For example, the code rate information 63 includes, for each of the codewords, an identifier indicative of each of the blocks to which the codeword is written, information indicative of the number of blocks to which the codeword is written, and information indicative of the number of blocks to which the one or more erasure recovery codes are written. When a codeword is written to the NAND flash memory 5, the code rate information 63 corresponding to this code word is generated. In addition, when executing the erasure recovery process for a certain codeword, the erasure recovery decoding unit 472 obtains information corresponding to this codeword, by referring to the code rate information 63.

Next, an example of the functional configuration of the CPU 42 will be described. The CPU 42 functions as a cumulative error count calculation unit 421, a cumulative write amount calculation unit 422, a cumulative read amount calculation unit 423, a write control unit 424, a code rate change unit 425, and a code rate information generation unit 425. Several or all parts of each function of the CPU 42 may be implemented by dedicated hardware of the controller 4.

The cumulative error count calculation unit 421 calculates a cumulative value of the number of times a data error occurs as a cumulative error count. The data error means that the SSD 3 fails returning correct data (correct read data) to the host 2. That is, the data error is an error that fails to return correct data to the host 2. The number of times the data errors occur is the number of times an uncorrectable error occurs. The uncorrectable error is an error which cannot be recovered by the erasure recovery process using the one or more erasure recovery codes. Even if loss of data occurs, if the lost data can be recovered by the erasure recovery process, the occurrence of the lost data is not counted as the occurrence of a data error. This is because the recovered correct data can be sent to the host 2. When a data error occurs, the correct read data requested by the read command cannot be sent to the host 2. For this reason, the memory system 3 notifies the host 2 of an error message indicating that an error has occurred. A data error occurs, for example, when the amount of lost data is larger than the amount of erasure recovery codes included in the codeword. For example, the number of times the data errors occur is counted in units of sectors. For example, when sending two sectors of correct read data to the host 2 is failed, the cumulative error count may be incremented by 2.

The cumulative write amount calculation unit 422 calculates a cumulative value of the size of the write data to be written based on write commands received from the host 2 as the cumulative write amount. The cumulative write amount is indicative of the total amount of write data written to the NAND flash memory 5 based on the write commands received from the host 2.

The cumulative read amount calculation unit 423 calculates the cumulative value of the size of read data requested by each of the read commands received from the host 2 as the cumulative read amount. The cumulative read amount is indicative of the total amount of read data requested to be read from the NAND flash memory 5 by the read commands received from the host 2.

The write control unit 424 receives write data from the host 2 based on the write command received from the host 2. The write control unit 424 writes the received write data to the NAND flash memory 5. The write control unit 424 determines the block to which the received write data is to be written. The write control unit 424 determines the block to which the write data is to be written such that wear leveling of reducing a difference in erase count the blocks included in the NAND flash memory 5 is executed. More specifically, the write control unit 424 executes an operation of selecting a block having the smallest erase count from among a plurality of free blocks and an operation of assigning the selected block as a block to which the write data is to be written. Thus, wear leveling to reduce the difference in the erase count between the blocks used in the SSD 3 is performed.

In addition, the write control unit 424 reads copy target data stored in the NAND flash memory 5 and writes the read copy target data to another block in the NAND flash memory 5, based on the copy command. The copy command can be issued from the host 2. Instead of being issued from the host 2, the copy command may be issued internally by the controller 4 based on a garbage collection operation.

The write control unit 424 manages a plurality of block groups. Each of the plurality of block groups includes two or more blocks BLKs (physical blocks) of the plurality of blocks BLKs (physical blocks) included in the NAND flash memory 5. The block group is also referred to as a super block.

The code rate change unit 425 changes the code rate of the write data to be written to the NAND flash memory 5. The encoding rate changing unit 425 selects, for example, a cumulative value having the smaller of the two cumulative values of cumulative write volume and cumulative read volume. The code rate change unit 425 calculates a value obtained by dividing the cumulative error count by the selected cumulative value (the cumulative write volume or the cumulative read volume). The code rate change unit 425 compares the calculated value with a first threshold value and, when the calculated value is less than the first threshold value, changes the code rate such that the code rate becomes a larger value. The maximum value of the code rate is 1. In addition, the code rate change unit 425 compares the calculated value with a second threshold value and, when the calculated value is larger than or equal to the second threshold value, changes the code rate such that the code rate becomes a smaller value. The second threshold value is the same value as or larger than the first threshold value.

Thus, the code rate change unit 425 changes the code rate based on a value obtained by dividing the cumulative error count by the cumulative write amount or the cumulative read amount.

The value obtained by dividing the cumulative error count by the cumulative write amount or the cumulative read amount is indicative of a rate of occurrence of data errors. This rate is also referred to as uncorrectable bit error rate (UBER). The rate of occurrence of data errors, which is referred to as UBER, is desirably suppressed below a certain value in order to maintain the reliability of the SSD 3. UBER is generally represented by the following expression.

UBER=[number of data errors]/[number of bits read].

When the cumulative write amount is equal to the cumulative read amount, the value obtained by dividing the cumulative error count by the cumulative write amount is consistent with a normal definition of UBER represented by the above expression. For this reason, UBER can be calculated by dividing the cumulative error count by the cumulative read amount or can be calculated by dividing the cumulative error count by the cumulative write amount.

The ratio between the amount of data required to be written by the host 2 and the amount of data required to be read by the host 2 may not be equal, and the cumulative read amount may be greater than the cumulative write amount. In this case, if the value obtained by dividing the cumulative error count by the cumulative read amount is always used as UBER, a lower value may be calculated as UBER as compared with a case of using the value obtained by dividing the cumulative error count by the cumulative write amount.

On the other hand, the cumulative write amount may be larger than the cumulative read amount. In this case, if the value obtained by dividing the cumulative error count by the cumulative write amount is always used as UBER, a lower value may be calculated as UBER as compared with a case of using the value obtained by dividing the cumulative error count by the cumulative read amount.

For this reason, in the embodiment, when the cumulative read amount is larger than the cumulative write amount, the value obtained by dividing the cumulative error count by the cumulative write amount may be used as the rate of occurrence of the data errors.

In addition, when the cumulative write amount is larger than the cumulative read amount, the value obtained by dividing the cumulative error count divided by the cumulative read amount may be used as the rate of occurrence of the data errors.

Thus, the rate of occurrence of the data errors can be obtained on a stricter basis by selectively using the cumulative write volume and the cumulative read volume. The case of selecting the smaller of the cumulative read amount and the cumulative write amount and using a value obtained by dividing the cumulative error count by the selected value as UBER will be mainly described below.

The code rate information generation unit 426 generates the code rate information corresponding to the codeword to be written to the NAND flash memory 5. When a codeword including the write data received from the host 2 is written to the NAND flash memory 5, the code rate information generation unit 426 generates the code rate information 63 corresponding to this codeword and stores the generated information in the DRAM 6.

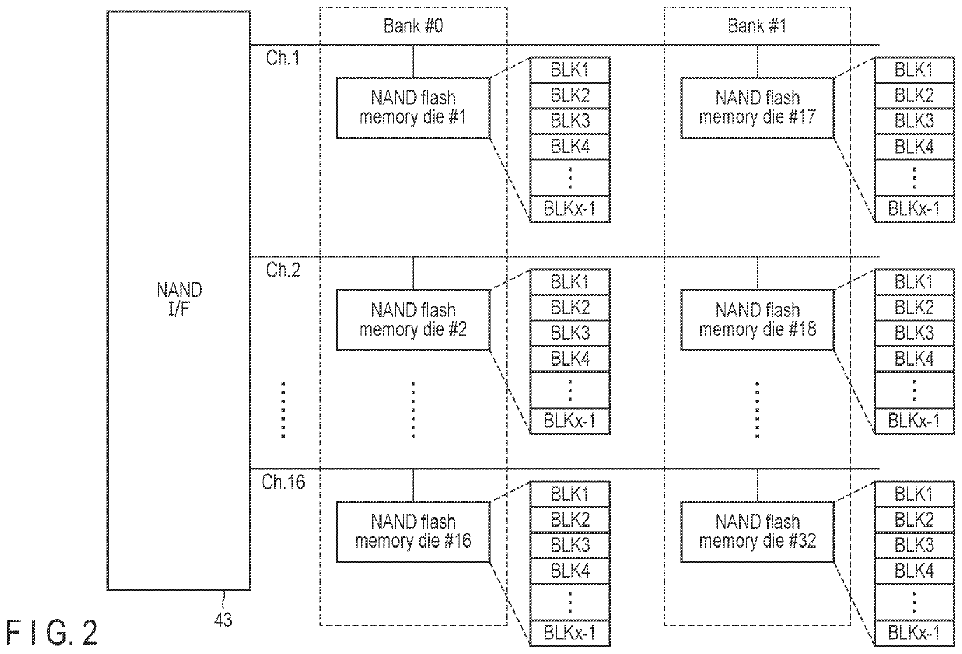

Next, the configuration of the NAND flash memory 5 that includes a plurality of NAND flash memory dies will be described. FIG. 2 is a block diagram illustrating an example of a relationship between a plurality of channels and a plurality of NAND flash memory dies, which are used in the memory system according to the embodiment.

Each of the plurality of NAND flash memory dies can operate independently. For this reason, the NAND flash memory die is treated as a unit for parallel operation. In FIG. 2, a case where sixteen channels Ch. 1 to Ch. 16 are connected to the NAND interface (I/F) 43 and two NAND flash memory dies are connected to each of sixteen channels Ch. 1 to Ch. 16 is exemplified.

In this case, sixteen NAND flash memory dies #1 to #16 connected to the channels Ch. 1 to Ch. 16 may be configured as bank #0 and the remaining sixteen NAND flash memory dies #17 to #32 connected to the channels Ch. 1 to Ch. 16 may be configured as bank #1. The bank is treated as a unit for causing a plurality of memory dies to execute the parallel operation by bank interleaving. In the configuration example shown in FIG. 2, a maximum of thirty-two NAND flash memory dies can be operated in parallel by sixteen channels and the bank interleaving using two banks.

The data erase operation may be executed in a unit of single block (physical block) or a unit of block group (super block) including a set of a plurality of physical blocks capable of executing the parallel operation.

One block group, i.e., one super block including a set of a plurality of physical blocks is not limited to this example, but may include a total of thirty-two physical blocks that are selected from the NAND flash memory dies #1 to #32, respectively. Each of the NAND flash memory dies #1 to #32 may have a multiplane configuration. For example, when each of the NAND flash memory dies #1 to #32 includes a multi-plane configuration including two planes, one super block may include a total of sixty-four physical blocks that are selected from sixty-four planes corresponding to the NAND flash memory dies #1 to #32, respectively.

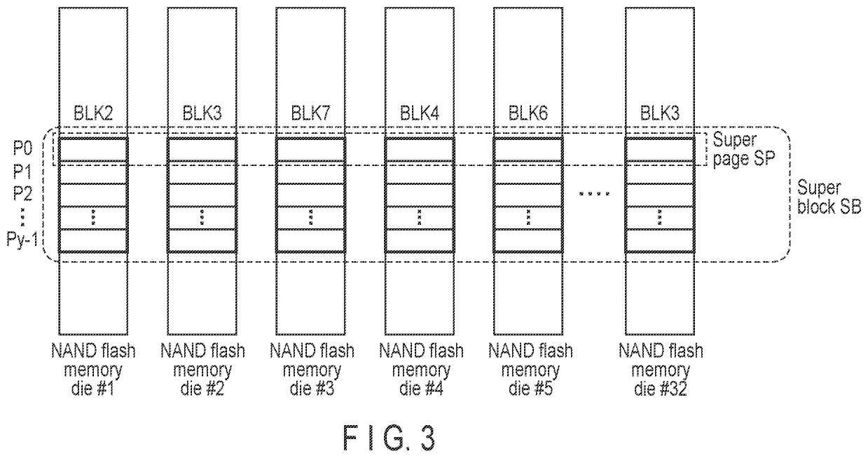

FIG. 3 illustrates an example of a super block (SB) including thirty-two physical blocks (in this example, physical block BLK2 in the NAND flash memory die #1, physical block BLK3 in the NAND flash memory die #2, physical block BLK7 in the NAND flash memory die #3, physical block BLK4 in the NAND flash memory die #4, physical block BLK6 in the NAND flash memory die #5, . . . , physical block BLK3 in the NAND flash memory die #32).

Each super block may include only one physical block and, in this case, a single super block is equivalent to a single physical block.

The super block includes the same number of logical pages as the pages (physical pages) P0 to Py−1 included in the respective physical blocks included in the super block. The logical page is also referred to as a super page. One super page includes thirty-two physical pages whose number is the same as the number of physical blocks included in the super block. For example, the first super page of the super block illustrated in the figure includes physical pages P1 of the physical blocks BLK2, BLK3, BLK7, BLK4, BLK6, . . . , and BLK3 of the NAND flash memory dies #0, #2, #3, #4, #5, . . . , and #32.

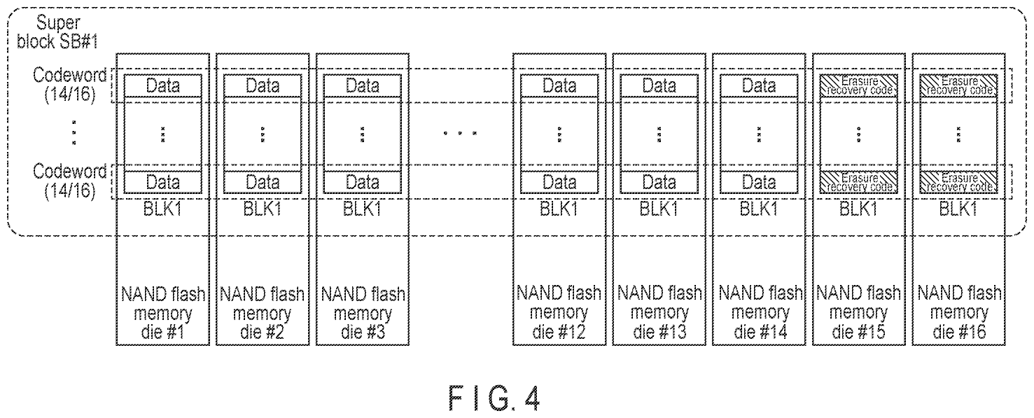

Next, a super block in which the codewords encoded at a first code rate are written will be described. FIG. 4 is a diagram illustrating a first example of a super block to which data is written at a first code rate in the memory system according to the embodiment. A case where codewords generated using a code rate of 14/16 are written to super block SB #1 will be described with reference to FIG. 4. The super block SB #1 is composed of blocks BLK1 of the respective NAND flash memory dies #1, #2, . . . , and #16. For this reason, the number of physical blocks included in the super block SB #1 is sixteen.

Each of the codewords written to the super block SB #1 is encoded at the code rate of 14/16. For this reason, the total number of symbols included in the codeword is sixteen. Fourteen symbols of the sixteen symbols are information symbols, which are pieces of write data. Two symbols of the sixteen symbols are redundant symbols, which are erasure recovery codes.

Each of the plurality of codewords is written across sixteen blocks BLK1 respectively included in the NAND flash memory dies #1, #2, . . . , and #16. In each of the plurality of codewords, the data written to each of fourteen blocks BLK1 respectively included in the NAND flash memory dies #1, #2, . . . , and #14 is write data having the size of one page. Each of the fourteen blocks BLK1 respectively included in the NAND flash memory dies #1, #2, . . . , and #14 is used as a block for storing only the data included in each of the plurality of codewords, and is not used as a block for storing the erasure recovery code included in each of the plurality of codewords. For this reason, the data and the erasure recovery code are not mixed in the same block. After a next erase operation for the super block SB #1 is executed, each of the fourteen blocks BLK1 respectively included in the NAND flash memory dies #1, #2, . . . , and #14 may be used as a block for storing only the data or may be used as a block for storing only the erasure recovery code.

The erasure recovery code written to each of the two blocks BLK1 respectively included in the NAND flash memory dies #15 and #16 is a redundant code having the size of one page. Each of the two blocks BLK1 respectively included in the NAND flash memory dies #15 and #16 is used as a block for storing only the erasure recovery code included in each of the plurality of codewords, and is not used as a block for storing the data included in each of the plurality of codewords. After a next erase operation for the super block SB #1 is executed, each of the two blocks BLK1 respectively included in the NAND flash memory dies #15 and #16 may be used as a block for storing only the erasure recovery code or may be used as a block for storing only the data.

Thus, the super block SB #1 to which the codeword encoded at the code rate of 14/16 is written includes two physical blocks to which only the erasure recovery code is written. Therefore, the controller 4 can recover the lost data up to two physical blocks (i.e., two pieces of write data) per codeword. In other words, the maximum number of symbols of the lost data that can be recovered per codeword is 2.

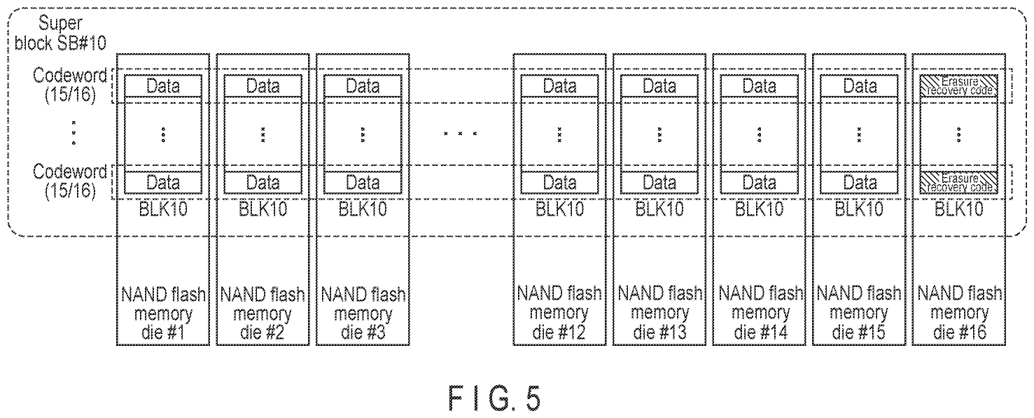

Next, a super block to which a codeword encoded at the second code rate is written will be described. FIG. 5 is a diagram illustrating a second example of the super block to which data is written at a second code rate in the memory system according to the embodiment. A case in which codewords generated using a code rate 15/16 are written to super block SB #10 will be described with reference to FIG. 5. The super block SB #10 is composed of blocks BLK10 of the respective NAND flash memory dies #1, #2, . . . , and #16. For this reason, the number of physical blocks included in the super block SB #10 is sixteen.

Each of the codewords written to the super block SB #10 is encoded based on the code rate 15/16. For this reason, the total number of symbols in the codeword is sixteen. Fifteen symbols of the sixteen symbols are information symbols, which are pieces of write data. One of the sixteen symbols is a redundant symbol, which is an erasure recovery code.

The data written to each of the fifteen blocks BLK10 respectively included in the NAND flash memory dies #1, #2, . . . , and #15 is write data having the size of one page. Each of the fifteen blocks BLK10 respectively included in the NAND flash memory dies #1, #2, . . . , and #15 is used as a block to store only the data until a next erase operation for the super block SB #10 is executed.

The erasure recovery code written to the block BLK10 included in the NAND flash memory die #16 is a redundant code having the size of one page. The block BLK10 of the NAND flash memory die #16 is used as a block to store only the erasure recovery code until a next erase operation for the super block SB #10 is executed.

Thus, the super block SB #10 to which the codeword encoded at the code rate of 15/16 is written includes only one physical block to which only the erasure recovery code is written. Therefore, the controller 4 can recover the lost data in only one physical block (i.e., one piece of write data) per codeword. In other words, the number of symbols of the lost data that can be recovered per codeword is one.

The codewords encoded at the code rate of 15/16 have a lower erasure recovery capability than the codewords encoded at the code rate of 14/16, but the amount of the erasure recovery code wasted when not used is smaller, which can suppress the increase in write amplification.

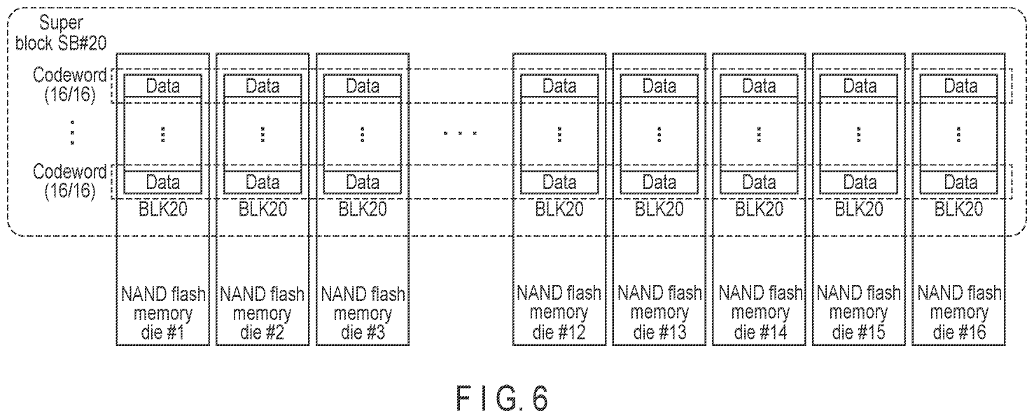

Next, super blocks to which codewords encoded at a third code rate are written will be described. FIG. 6 is a diagram illustrating a third example of a super block to which data is written at a third code rate in the memory system according to the embodiment. A case in which codewords generated using a code rate of 16/16 are written in super block SB #20 will be described with reference to FIG. 6. The super block SB #20 is composed of blocks BLK20 of the respective NAND flash memory dies #1, #2, . . . , and #16. For this reason, the number of physical blocks included in the super block SB #20 is sixteen.

Each of the codewords written to the super block SB #20 is encoded based on the code rate of 16/16 (=1). For this reason, the total number of symbols included in the codeword is sixteen. All of the sixteen symbols are information symbols, which are pieces of write data. For this reason, the codeword does not include a redundant symbol which is an erasure recovery code.

The data written to each of the sixteen blocks BLK20 respectively included in the NAND flash memory dies #1, #2, . . . , and #16 is write data having the size of one page. Each of the sixteen blocks BLK20 respectively included in the NAND flash memory dies #1, #2, . . . , and #16 is used as a block to store only the data until a next erase operation for the super block SB #20 is executed.

Thus, the super block SB #20 to which the codeword encoded at the code rate of 16/16 is written does not include a physical block to which only the erasure recovery code is written. Therefore, the controller 4 cannot recover the lost data.

The codewords encoded at the code rate of 16/16 have a lower erasure recovery capability than the codewords encoded at the code rate of 15/16, but there is no amount of the erasure recovery code wasted when not used, which can further suppress the increase in write amplification.

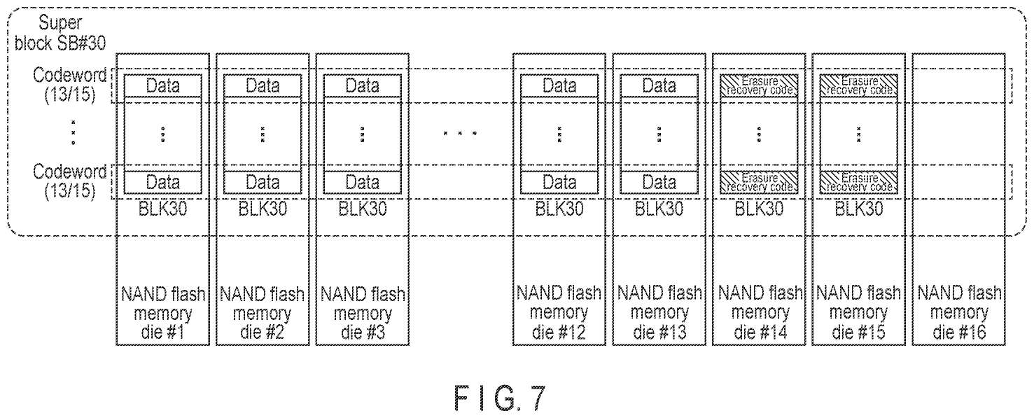

Next, super blocks to which codewords encoded at a fourth code rate are written will be described. FIG. 7 is a diagram illustrating a fourth example of a super block to which data is written at a fourth code rate in the memory system according to the embodiment.

A case in which a codeword generated using a code rate of 13/15 is written to super block SB #30 will be described with reference to FIG. 7. The super block SB #30 does not include, for example, the block included in the NAND flash memory die #16, and is composed of blocks BLK30 of the respective NAND flash memory dies #1, #2, . . . , and #15. For this reason, the number of physical blocks included in the super block SB #30 is fifteen. The block of the NAND flash memory die #16 that should belong to the super block SB #30 is, for example, a defective block.

Each of the codewords written to the super block SB #30 is encoded based on a code rate of 13/15. For this reason, the total number of symbols included in the codeword is fifteen. Thirteen symbols of the fifteen symbols are information symbols, which are pieces of write data. Two symbols of the fifteen symbols are redundant symbols, which are erasure recovery codes.

The data written to each of the thirteen blocks BLK30 respectively included in the NAND flash memory dies #1, #2, . . . , and #13 is write data having the size of one page. The thirteen blocks BLK30 respectively included in the NAND flash memory dies #1, #2, . . . , and #13 are used as blocks to store only the data until a next erase operation for the super block SB #30 is executed.

The erasure recovery code written to each of the two blocks BLK30 respectively included in the NAND flash memory dies #14 and #15 is a redundant code having the size of one page. Each of the two blocks BLK30 respectively included in the respective NAND flash memory dies #14 and #15 is used as a block to store only the erasure recovery code until a next erase operation for the super block SB #30 is executed.

Thus, the super block SB #30 to which the codeword encoded at the code rate of 13/15 is written includes only two physical blocks to which only the erasure recovery code is written. In addition, the number of write data included in one codeword is thirteen. For this reason, the erasure recovery process for two of the thirteen pieces of the write data can be executed successfully.

The codewords encoded at the code rate of 13/15 have a higher erasure recovery capability than the codewords encoded at the code rate of 14/16. This is because the codewords encoded with the code rate of 14/16 can successfully execute the erasure recovery process for two of fourteen pieces of the write data while the codewords encoded with the code rate of 13/15 can successfully execute the erasure recovery process for two of thirteen pieces of the write data. In addition, the codewords encoded at the code rate of 13/15 have a lower erasure recovery capability than the codewords encoded at the code rate of 13/16, which can suppress the increase in write amplification.

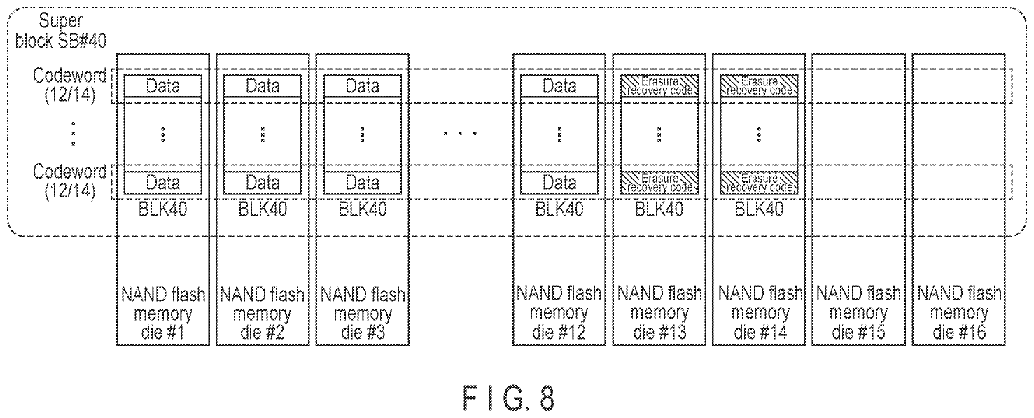

Next, super blocks to which codewords encoded at a fifth code rate are written will be described. FIG. 8 is a diagram illustrating a fifth example of a super block to which data is written at a fifth code rate in the memory system according to the embodiment.

A case in which a codeword generated using a 12/14 code rate is written to super block SB #40 will be described with reference to FIG. 8. The super block SB #40 does not include, for example, the block included in the NAND flash memory die #15 and the block included in the NAND flash memory die #16, and is composed of blocks BLK30 of the respective NAND flash memory dies #1, #2, . . . , and #14. For this reason, the number of physical blocks included in the super block SB #40 is fourteen. Each of the block in the NAND flash memory die #15 which should belong to the super block SB #40 and the block in the NAND flash memory die #16 which should belong to the super block SB #40 is a defective block.

Each of the codewords written to the super block SB #40 is encoded based on a code rate 12/14. For this reason, the total number of symbols included in the codeword is fourteen. Twelve symbols of the fourteen symbols are information symbols, which are pieces of write data. Two of the fourteen symbols are redundant symbols, which are erasure recovery codes.

The data written to each of the twelve blocks BLK40 respectively included in the NAND flash memory dies #1, #2, . . . , and #12 is write data having the size of one page. The twelve blocks BLK40 respectively included in the NAND flash memory dies #1, #2, . . . , and #12 are used as blocks to store only the data until a next erase operation for the super block SB #40 is executed.

The erasure recovery code written to each of the two blocks BLK40 included in the respective NAND flash memory dies #13 and #14 is a redundant code having the size of one page. Each of the two blocks BLK40 respectively included in the NAND flash memory dies #13 and #14 is used as a block to store only the erasure recovery code until a next erase operation for the super block SB #40 is executed.

Thus, the super block SB #40 to which the codeword encoded at the code rate of 12/14 is written includes only two physical blocks to which only the erasure recovery code is written. The number of write data included in one codeword is twelve. For this reason, the erasure recovery process for two of the twelve pieces of the write data can be executed successfully.

The codewords encoded at the code rate of 12/14 have a higher erasure recovery capability than the codewords encoded at the code rate of 13/15. This is because the codewords encoded with the code rate of 13/15 can successfully execute the erasure recovery process for two of thirteen pieces of the write data while the codewords encoded with the code rate of 12/14 can successfully execute the erasure recovery process for two of twelve pieces of the write data. In addition, the codewords encoded at the code rate of 12/14 have a lower erasure recovery capability than the codewords encoded at the code rate of 13/16, which can suppress the increase in write amplification.

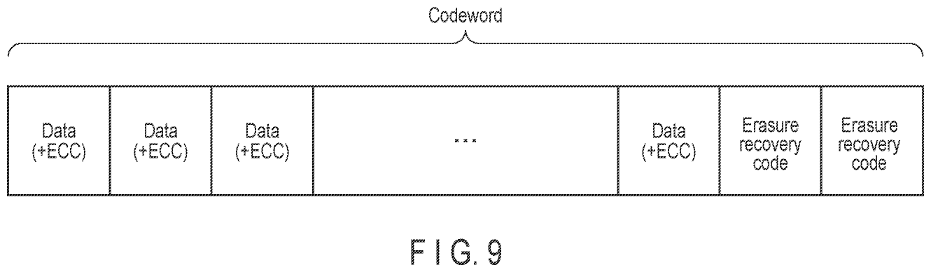

Next, the codeword will be described. FIG. 9 is a diagram illustrating the codeword generated based on the first code rate in the memory system according to the embodiment. The first code rate is 14/16.

In FIG. 9, the number of symbols in the codeword in FIG. 9 is sixteen. Fourteen of the sixteen symbols are information symbols and two symbols are redundant symbols.

The information symbols included in the codeword are data. The data is, for example, write data received from the host 2. ECC is added to each pieces of the data by the controller 4. When reading the data, the controller 4 executes error correction of the read data using the ECC added to the read data.

The redundancy symbol included in the codeword is an erasure recovery code. The erasure recovery code is generated by encoding all the data included in this codeword based on the code rate.

When one piece of the data in the codeword is specified by the read command received from the host 2, the controller 4 reads the specified data from the NAND flash memory 5. The controller 4 executes error correction of the read data using the ECC attached to the read data. When the controller 4 successfully executes the error correction using the ECC, the controller 4 transmits the read data to the host 2. When the error correction using the ECC is failed, the controller 4 starts the erasure recovery process for the read data (lost data).

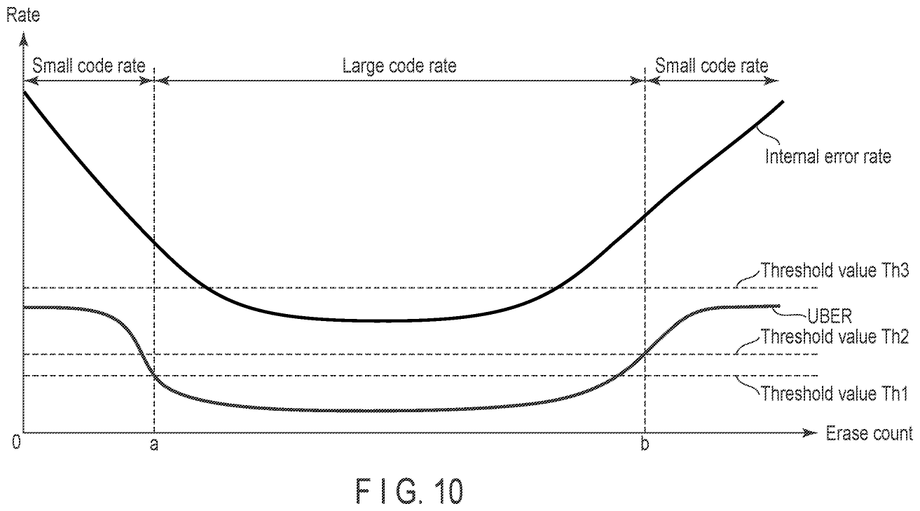

Next, transition of the number of errors in the memory system 3 will be described. FIG. 10 is a diagram illustrating the internal error rate and UBER in the memory system according to the embodiment.

A vertical axis is indicative of the rate. A horizontal axis is indicative of the erase count of each of a plurality of blocks included in the memory system 3. Since wear leveling is executed by the controller 4, the erase count of each of the plurality of blocks included in the memory system 3 has an approximately equal value. For this reason, the erase count on the horizontal axis is indicative of, for example, the erase count for any block in the memory system 3. The cumulative write amount and the cumulative read amount increase as the time elapses. Since the erase count of each block increases as the cumulative write volume increases, the erase count of each block also increases as the time elapses.

The internal error rate shown in the graph is a curve that is indicative of the ratio of the number of occurrence of data loss to the cumulative read amount (or cumulative write amount).

As for the internal error rate, for example a comparatively large value is measured due to an influence of reading the data from a defective storage location in a defective block (bad block) which is not registered as an unusable block at the start of operation of the memory system 3 (for example, during a period from erase count “0” to erase count “a”). During this time period, the block determined as a bad block is registered as an unusable block, and the internal error rate thereby decreases gradually.

The internal error rate remains stable during the period of stable operation (for example, during a period from erase count “a” to erase count “b”).

When the memory system 3 wears as the erase count of each block increases (for example, after erase count “b”), the internal error rate tends to increase again.

The UBER shown in the graph is a curve that is indicative of the rate of occurrence of the data errors to the cumulative read amount (or cumulative write amount). A difference between the internal error rate and the UBER is the number of times the lost data is successfully recovered by the erasure recovery process.

In the embodiment, a code rate of a small value (i.e., an erasure recovery code having a high erasure recovery capability) is used at the start of operation of the memory system 3 (for example, during a period from erase count “0” to erase count “a”) since the influence of bad blocks is large. For example, a predetermined code rate of less than 1 (default code rate) is used. In addition, when the UBER increases to a value close to a threshold value Th3, the code rate is changed to a value smaller than the default code rate. The UBER can be thereby controlled within a range that does not exceed the threshold value Th3 (for example, 1/10¹⁷). Then, when the internal error rate gradually decreases, the UBER also begins to decrease.

When the value of UBER falls below the threshold value Th1 (at erase count “a”), the controller 4 determines that the memory system 3 is in stable operation and changes the code rate to a larger value. As a result, the erasure recovery capability of the erasure recovery code written to the NAND flash memory 5 is reduced. However, since the internal error rate during the period from erase count “a” to erase count “b” is relatively low, the UBER is controlled within a range not exceeding the threshold value Th3 (for example, 1/10¹⁷) even when a codeword having a low erasure recovery capability is written to the NAND flash memory 5. In addition, since the amount of the erasure recovery codes written to the NAND flash memory 5 is reduced, the increase in write amplification can be suppressed. Furthermore, the over-provisioning area can be increased by the amount of the reduced erasure recovery codes.

As the erase count of each block increases, the memory system 3 gradually wears and the internal error rate increases. As the internal error rate increases, the value of the UBER also gradually increases. When the value of the UBER become higher than or equal to the threshold value Th2 (at erase count “b”), the controller 4 changes the code rate to a smaller value in order to use the erasure recovery code having a high erasure recovery capability. The UBER can be thereby controlled within a range that does not exceed the threshold value Th3 (for example, 1/10¹⁷).

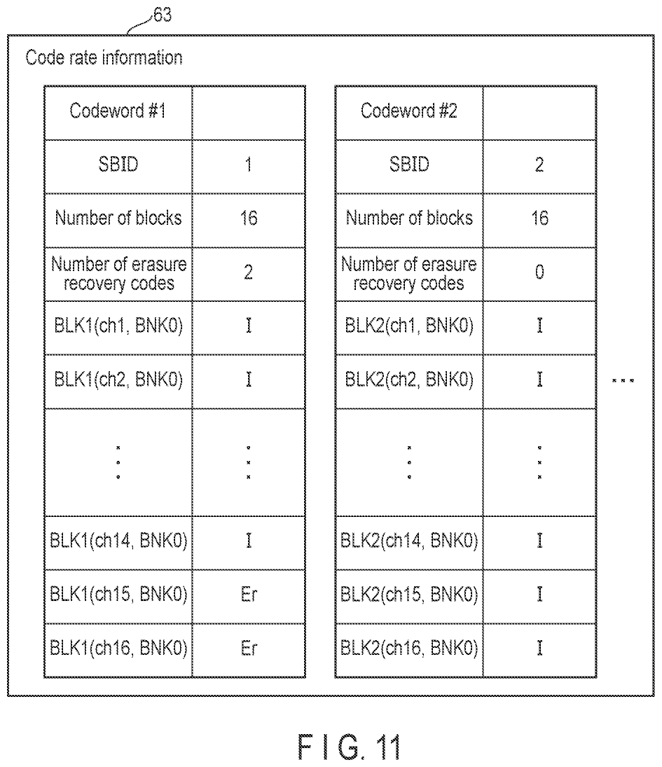

Next, the code rate information 63 will be described. FIG. 11 is a diagram illustrating the code rate information used in the memory system according to the embodiment. The code rate information 63 corresponding to codeword #1 written to super block SB #1 and codeword #2 written to super block SB #2 respectively is illustrated in FIG. 11.

For example, the codeword #1 is written to the super block SB #1 at a code rate of 14/16. In addition, the codeword #2 is written to the super block SB #2 at a code rate of 16/16.

The code rate information 63 corresponding to the codeword #1 is generated when the codeword #1 is written across a plurality of blocks included in the super block SB #1. The code rate information 63 includes information indicative of the super block identifier (SBID), the number of blocks, the number of erasure recovery codes, and the identifiers of the plurality of blocks to which each of the plurality of symbols included in the codeword #1 is written.

The SBID corresponding to the codeword #1 is indicative of the identifier of the super block SB #1 (=1).

The number of blocks corresponding to the codeword #1 is indicative of sixteen, which corresponds to the number of physical blocks included in the super block SB #1. A value indicative of the total number of symbols included in the codeword #1 may be indicated instead of the number of blocks.

The number of erasure recovery codes corresponding to the codeword #1 is indicative of the number of erasure recovery codes (=2) included in the codeword #1. The number of erasure recovery codes is the number of redundant symbols included in the codeword #1. The controller 4 can obtain the code rate corresponding to the codeword #1 by referring to the number of blocks and the number of erasure recovery codes. The code rate corresponding to the codeword #1 is (16-2)/16=14/16.

The super block SB #1 to which the codeword #1 is written includes sixteen physical blocks BLK1 included in the respective sixteen NAND flash memory dies, which are connected to the channels ch1 to ch16 and included in the bank #0. Each of the sixteen NAND flash memory dies is identified by the channel number ch and the bank number BNK. For this reason, the code rate information 63 corresponding to the codeword #1 includes information indicative of BLK1 (ch1, BNK0), BLK1 (ch2, BNK0), . . . , BLK1 (ch14, BNK0), BLK1 (ch15, BNK0), and BLK1 (ch16, BNK0), as identifiers of a plurality of blocks. For example, BLK1 (ch1, BNK0) is indicative of the physical block BLK1 included in the NAND flash memory die #1.

The code rate information 63 includes attribute information indicating whether the symbol to be written to each physical block is data (I) or an erasure recovery code (Er). The attribute information corresponding to BLK1 (ch0, BNK0), . . . , BLK1 (ch14, BNK0) is I, which indicates that the symbol to be written is data. In addition, the attribute information corresponding to BLK1 (ch15, BNK0) and BLK1 (ch16, BNK0) is Er, which indicates that the symbol to be written is an erasure recovery code.

In addition, the SBID corresponding to the codeword #2 is indicative of the identifier (=2) of the super block SB #2.

The number of blocks corresponding to the codeword #2 is indicative of sixteen, which corresponds to the number of physical blocks included in the super block SB #2. A value indicative of the total number of symbols included in the codeword #2 may be indicated instead of the number of blocks.

The number of erasure recovery codes corresponding to the codeword #2 is indicative of the number of erasure recovery codes (=1) included in the codeword #2. The code rate corresponding to the codeword #2 is (16-1)/16=15/16.

The super block SB #2 to which the codeword #2 is written includes sixteen physical blocks BLK2 included in the respective sixteen NAND flash memory dies, which are connected to the channels ch1 to ch16 and included in the bank #0. Each of the sixteen NAND flash memory dies is identified by the channel number ch and the bank number BNK. For this reason, the code rate information 63 corresponding to the codeword #2 includes information indicative of BLK2 (ch1, BNK0), BLK2 (ch2, BNK0), . . . , BLK2 (ch14, BNK0), BLK2 (ch15, BNK0), and BLK2 (ch16, BNK0), as identifiers of a plurality of blocks.

The attribute information corresponding to BLK2 (ch1, BNK0), . . . , BLK2 (ch16, BNK0) is I, which indicates that the symbol to be written is data.

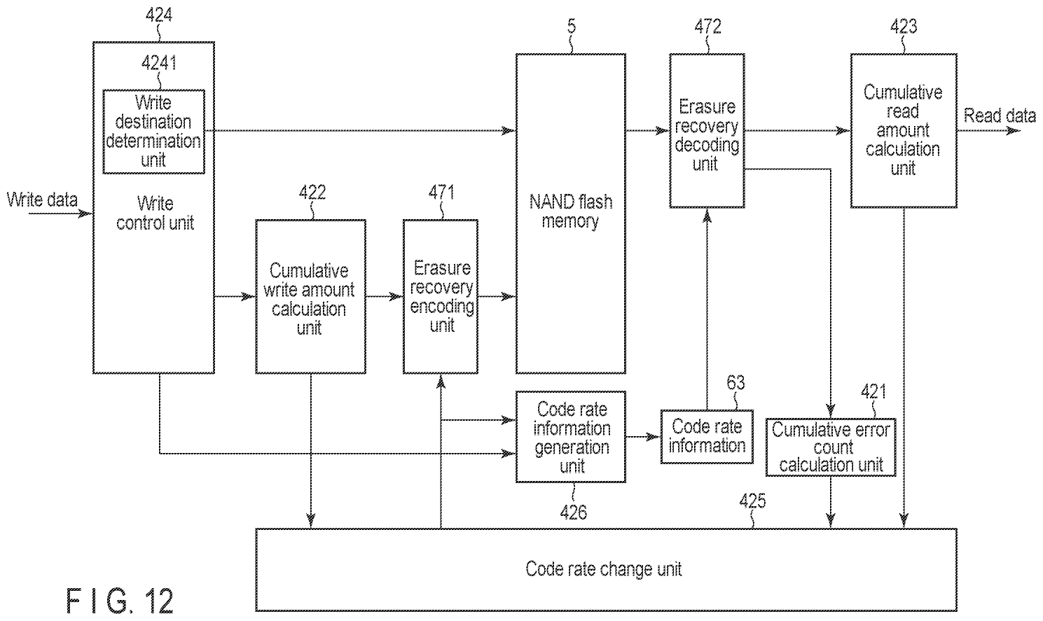

Next, the data write process and the data read process will be described. FIG. 12 is a diagram illustrating an example of the data write process and the data read process executed in the memory system according to the embodiment.

First, in the data write process, the write control unit 424 receives from the host 2 the write data associated with the received write command. A write destination determination unit 4241 of the write control unit 424 determines the super block to which the received write data is to be written. The write control unit 424 notifies the encode rate information generation unit 426 of the information indicative of the determined super block. The write control unit 424 sends the received write data to the cumulative write amount calculation unit 422.

The cumulative write amount calculation unit 422 calculates the cumulative write amount by adding the size of the received write data to the current cumulative write amount. The cumulative write amount calculation unit 422 notifies the code rate change unit 425 of the calculated cumulative write amount. Then, the cumulative write amount calculation unit 422 sends the received write data to the erasure recovery encoding unit 471.

The code rate change unit 425, which is notified of the cumulative write amount, compares the cumulative write amount with the cumulative read amount and selects a smaller cumulative value of the cumulative write the cumulative write volume with the cumulative read amount and the cumulative read amount. The code rate change unit 425 calculates a value obtained by dividing the cumulative error count calculated by the cumulative error count calculation unit 421 by the selected cumulative value. The code rate change unit 425 determines whether or not the calculated value is less than the first threshold value Th1. In addition, the code rate change unit 425 also determines whether or not the calculated value is greater than or equal to the second threshold value Th2. When the calculated value is less than the first threshold value Th1, the code rate change unit 425 changes the code rate such that the code rate becomes a value greater than the current code rate. On the other hand, when the calculated value is greater than or equal to the second threshold Th2, the code rate change unit 425 changes the code rate such that the coding rate becomes a value smaller than the current code rate. In a case where the second threshold Th2 is set to a value greater than the first threshold Th1, when the calculated value is greater than the first threshold Th1 and less than the second threshold Th2, the code rate change unit 425 maintains the current code rate.

When the code rate change unit 425 change the code rate, the code rate change unit 425 notifies the erasure recovery encoding unit 471 and the code rate information generation unit 426 of the changed code rate.

The erasure recovery encoding unit 471 executes encoding for the write data received from the cumulative write volume calculation unit 422. The erasure recovery encoding unit 471 generates a codeword to be written to the NAND flash memory 5 using the write data, based on the code rate notified by the code rate change unit 425. The erasure recovery encoding unit 471 transfers the generated codeword to the NAND flash memory 5.

In the NAND flash memory 5, the codeword is written to the super block of the write destination determined by the write destination determination unit 4241. The data to which the changed code rate is applied is new write data received from the host 2 and copy target data to be copied from a copy source memory location to a copy destination memory location in the NAND flash memory 5, based on the copy command from the host 2 or by garbage collection. The codewords generated using the code rate before the change and already written to the NAND flash memory 5 are retained in the NAND flash memory 5, and their code rates are not changed. When the data which is encoded using the code rate before the change is to be copied to the copy destination memory location as the copy target data based on the copy command from the host 2 or by garbage collection, the data is encoded using the changed code rate.

The code rate information generation unit 426 generates the code rate information 63 corresponding to the codeword to be written to the NAND flash memory 5 and stores the code rate information 63 in the DRAM 6.

In the data read operation, the data specified by the read command from the host 2 is read from the NAND flash memory 5. This read data is transferred to the erasure recovery decoding unit 472.

The erasure recovery decoding unit 472 executes error correction of the read data using the ECC added to the read data. When error correction using the ECC is executed successfully, the erasure recovery decoding unit 472 sends the read data to the cumulative read amount calculation unit 423.

The cumulative read amount calculation unit 423 calculates the cumulative read amount by adding the size of the received read data to the current cumulative read volume. The cumulative read volume calculation unit 423 notifies the code rate change unit 425 of the calculated cumulative read amount. Then, the cumulative read amount calculation unit 423 sends the read data to the host 2. The code rate change unit 425, which is notified of the cumulative read amount, executes the same process as that when notified of the cumulative write amount.

When the error correction of the read data using the ECC is failed, the read data is detected as lost data. For this reason, the erasure recovery decoding unit 472 executes the erasure recovery process for the read data. In this case, the erasure recovery decoding unit 472 obtains the code rate information corresponding to the codeword which includes the read data (lost data) from the code rate information 63. When this codeword does not include an erasure recovery code (coding rate=1), the erasure recovery decoding unit 472 notifies the cumulative error count calculation unit 421 of the occurrence of a data error. In this case, the host 2 is notified of a message indicating the occurrence of a data error by the controller 4. Furthermore, the erasure recovery decoding unit 472 may notify the cumulative read amount calculation unit 423 of the size of the read data (lost data). In this case, the cumulative read amount calculation unit 423 calculates the cumulative read amount by adding the size of the read data to the current cumulative read amount.

The cumulative error count calculation unit 421, which is notified of the data error, increments the cumulative error count by, for example, 1. In a case where the cumulative error count is counted in units of sectors, the cumulative error count is incremented by the number of sectors included in the read data (lost data). The cumulative error count calculation unit 421 notifies the code rate change unit 425 of the incremented cumulative error count. The code rate change unit 425, which is notified of the cumulative error count, executes the same process as that when notified of the cumulative write amount.

In addition, when the codeword including the read data (lost data) includes an erasure recovery code, the erasure recovery decoding unit 472 reads, from the NAND flash memory 5, (i) all remaining data included in this codeword, excluding the read data (lost data), and (ii) all erasure recovery codes included in this codeword. The erasure recovery decoding unit 472 executes the erasure recovery process to recover the read data (lost data) using all the read remaining data and all the read erasure recovery codes. When the erasure recovery process is executed successfully, the erasure recovery decoding unit 472 executes the same operation as that in the case of successfully executing the error correction using the ECC.

On the other hand, when the erasure recovery process is failed, the erasure recovery decoding unit 472 executes the same process as that when the codeword does not include an erasure recovery code.

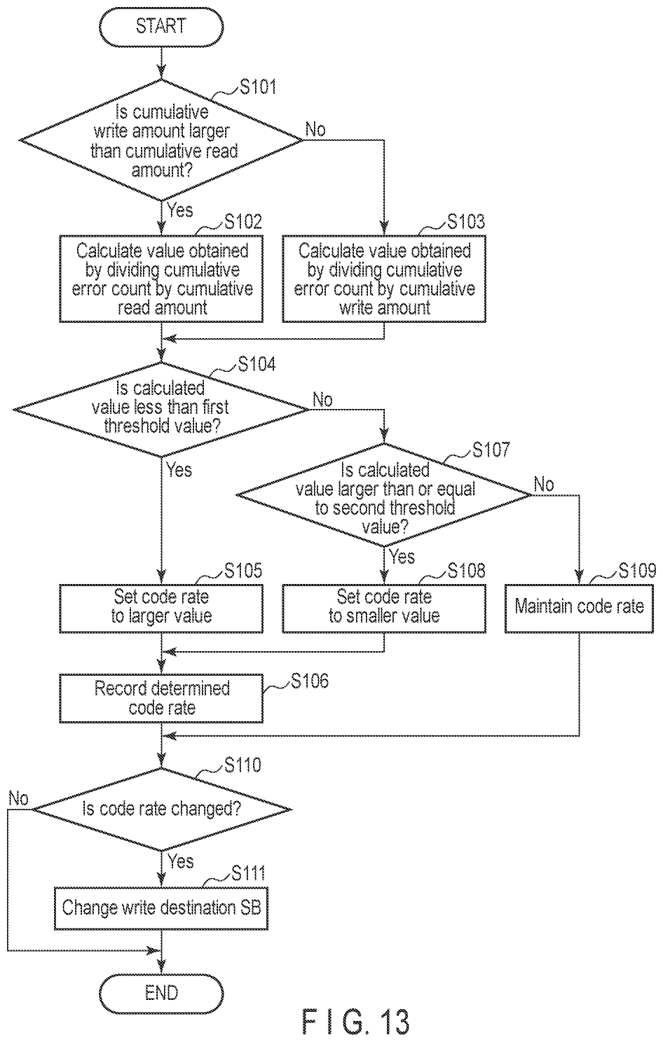

Next, the code rate change process will be described. FIG. 13 is a flowchart illustrating a procedure of the code rate change process executed in the memory system according to the embodiment. The controller 4 starts the code rate change process when either the cumulative error count, the cumulative write amount, or the cumulative read amount is updated.

The controller 4 determines whether or not the cumulative write amount is larger than the cumulative read amount (step S101).

When the cumulative write amount is larger than the cumulative read amount (Yes in step S101), the controller 4 calculates a value obtained by dividing the cumulative error count by the cumulative read amount (step S102).

When the cumulative write amount is smaller than the cumulative read amount (No in step S101), the controller 4 calculates a value obtained by dividing the cumulative error count by the cumulative write amount (step S103).

The controller 4 determines whether or not the calculated value is less than the first threshold value Th1 (step S104).

When the calculated value is less than the first threshold value Th1 (Yes in step S104), the controller 4 sets the code rate to a value larger than the current code rate (step S105). The maximum value of the code rate is 1.

The controller 4 records the determined code rate (step S106).

When the calculated value is larger than or equal to the first threshold value Th1 (No in step S104), the controller 4 determines whether or not the calculated value is larger than or equal to the second threshold value Th2 (step S107).

When the calculated value is larger than or equal to the second threshold value Th2 (Yes in step S107), the controller 4 sets the code rate to a value smaller than the current code rate (step S108) and records the determined code rate (step S106).

When the calculated value is less than the second threshold value Th2 (No in step S107), the controller 4 maintains the current code rate (step S109).

After the process in step S106 or S109, the controller 4 determines whether or not the code rate is changed (step S110).

When the code rate is changed (Yes in step S110), the controller 4 changes the super block allocated as the data write destination super block (step S111).

When the code rate is not changed (No in step S110), the controller 4 skips the process in step S111 and ends the code rate change process.

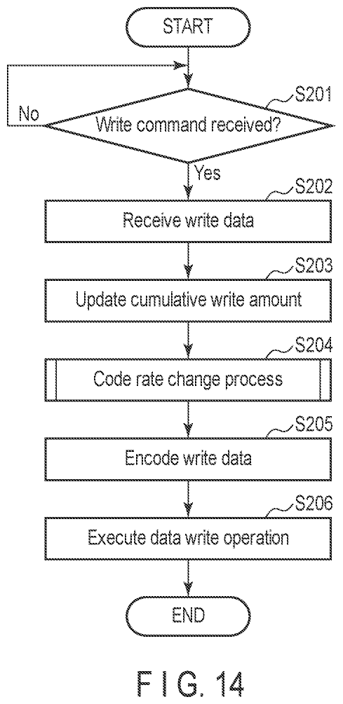

Next, the data write process will be described. FIG. 14 is a flowchart illustrating a procedure of the data write process executed in the memory system according to the embodiment.

First, the controller 4 determines whether or not the write command is received (step S201).

When the write command is not received (No in step S201), the controller 4 waits until the write command is received.

When the write command is received (Yes in step S201), the controller 4 receives the write data associated with the received write command from the host 2 (step S202).

The controller 4 updates the cumulative write amount by adding the size of the received write data to the current cumulative write amount (step S203).

The controller 4 executes the code rate change process described with reference to FIG. 13 (step S204).

When the code rate change process is ended, the controller 4 encodes a plurality of pieces of write data received from the host 2 and thereby generates a codeword for erasure recovery, based on the current code rate that is the changed code rate (step S205). When the current code rate is less than 1, the controller 4 encodes the plurality of pieces of write data and generates a codeword including the plurality of pieces of write data and one or more erasure recovery codes, based on the current code rate. When the current code rate is 1, the controller 4 generates a codeword including the plurality of pieces of write data and not including an erasure recovery code.

The controller 4 executes the data write operation of writing the generated codeword to the NAND flash memory 5 (step S206). In the data write operation, the controller 4 writes the codeword across a plurality of blocks included in the super block of the write destination such that the plurality of pieces of write data and the zero or more erasure recovery codes are written to different blocks in the NAND flash memory 5. When the code rate is changed, the super block of the write destination is changed and a new super block is allocated as the super block of the write destination. For this reason, codewords having different code rates cannot exist together in each super block.

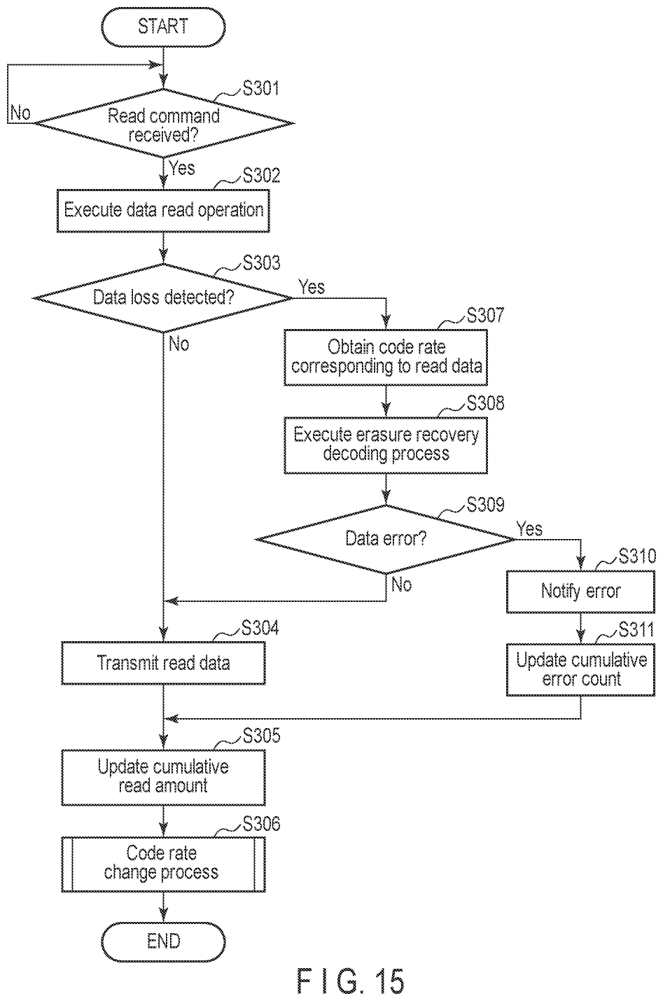

Next, the data read process will be described. FIG. 15 is a flowchart illustrating a procedure of the data read process executed in the memory system according to the embodiment.

First, the controller 4 determines whether or not the read command is received (step S301).

When the read command is not received (No in step S301), the controller 4 waits until the read command is received.

When the controller 4 receives the read command (Yes in step S301), the controller 4 executes the data read operation of reading the data specified by the read command from the NAND flash memory 5 (step S302).

The controller 4 determines whether or not loss of the data read in step S302 is detected (step S303).

When the data loss is not detected, i.e., when the error correction using the ECC added to the read data which has been read is executed successfully (No in step S303), the controller 4 transmits the read data (correct data) to the host 2 (step S304).

The controller 4 updates the cumulative read amount by adding the size of the transmitted read data to the current cumulative read amount (step S305).

The controller 4 executes the code rate change process described with reference to FIG. 13 (step S306).

When the data loss is detected, i.e., when the error correction using the ECC added to the read data is failed (Yes in step S303), the controller 4 obtains the code rate of the codeword including the read data from the code rate information 63 (step S307).

The controller 4 executes the erasure recovery process for the codeword including the read data by referring to the obtained code rate information 63 (step S308). In step S308, the controller 4 recovers the lost data using (i) the pieces of remaining data in the codeword, excluding the read data (lost data), and (ii) the redundant codes included in the codeword. This recovery process is executed when the amount of the read data (lost data) does not exceed the amount of the redundant codes of the codeword. The amount of the redundant codes of the codeword is determined based on the number of blocks to which the redundant codes are written. The number of blocks to which the redundant codes are written is indicated by the obtained code rate information 63.

The controller 4 determines whether or not a data error occurs (step S309). The data error occurs when the erasure recovery process is failed.

When the data error does not occur (No in step S309), the controller 4 transmits the successfully recovered read data to the host 2 (step S304).

The controller 4 updates the cumulative read amount by adding the size of the transmitted read data to the current cumulative read volume (step S305).

The controller 4 executes the code rate change process described with reference to FIG. 13 (step S306).

When the data error occurs (Yes in step S309), the controller 4 notifies the host 2 of an error message indicating that the correct read data cannot be sent (step S310).

The controller 4 updates the cumulative error count to a value incremented by, for example, 1 (step S311).

The controller 4 updates the cumulative read volume by adding the size of the read data in which the data error has occurred to the current cumulative read amount (step S305).

The controller 4 executes the code rate change process described with reference to FIG. 13 (step S306).

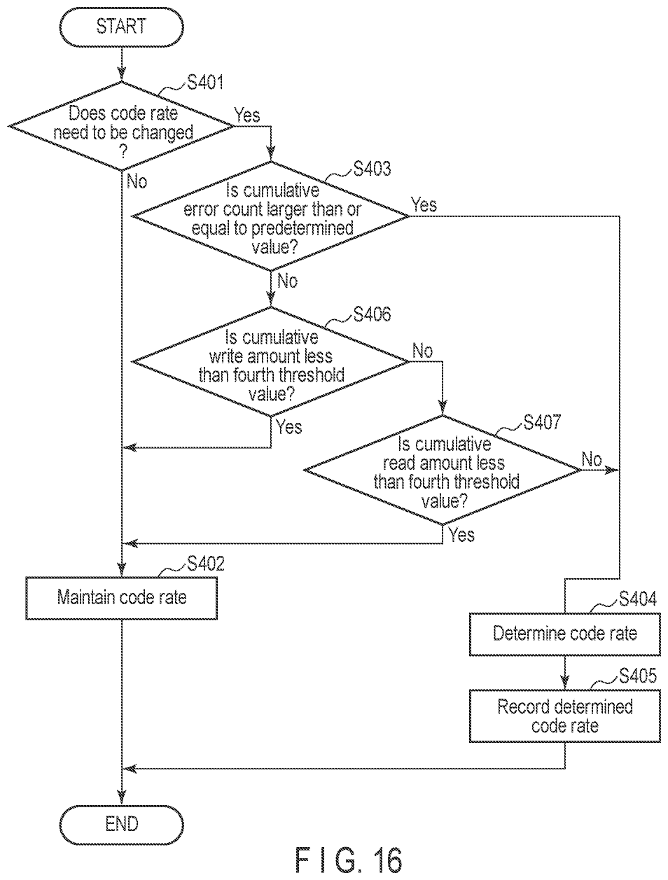

Next, the code rate change process in a case where the cumulative error count is less than a predetermined value and the code rate is not changed, in a situation that much time does not elapse after the memory system 3 starts the operation, will be described. FIG. 16 is a flowchart illustrating a second procedure of the code rate change process executed in the memory system according to the embodiment.

First, the controller 4 determines whether or not the code rate needs to be changed (step S401). For example, the controller 4 determines whether or not the code rate needs to be changed, by executing the processes of steps S101 to S104 and S107 described with reference to FIG. 13.

When the code rate does not need to be changed (No in step S401), the controller 4 maintains the code rate (step S402).

When the code rate needs to be changed (Yes in step S401), the controller 4 determines whether or not the cumulative error count is larger than or equal to a predetermined value (step S403).

When the cumulative error count is larger than or equal to a predetermined value (Yes in step S403), the controller 4 determines that the count of occurrence of the data errors is extremely increased, and determines a new code rate smaller than the current code rate (step S404).

The controller 4 records the new code rate determined in step S404 (step S405).

When the cumulative error count is less than a predetermined value (No in step S403), the controller 4 determines whether or not the cumulative write amount is less than a fourth threshold value (step S406). The fourth threshold value is a reference value for determining whether or not the cumulative write amount or the cumulative read amount reaches a predetermined amount.

When the cumulative write amount is less than the fourth threshold value (Yes in step S406), the controller 4 determines that the cumulative write amount is small and that reliability in the value (UBER) obtained by dividing the cumulative error count by the cumulative write amount is insufficient, and maintains the current code rate in order to place a high priority on safety (step S402).

When the cumulative write amount is larger than or equal to the fourth threshold value (No in step S406), the controller 4 determines whether or not the cumulative read amount is less than the fourth threshold value (step S407).

When the cumulative read amount is less than the fourth threshold value (Yes in step S407), the controller 4 determines that the cumulative read amount is small and that reliability in the value (UBER) obtained by dividing the cumulative error count by the cumulative read amount is insufficient, and maintains the current code rate in order to place a high priority on safety (step S402).

When the cumulative read amount is larger than or equal to the fourth threshold value (No in step S407), the controller 4 determines the code rate, based on the value obtained by dividing the cumulative error count by the smaller value of the cumulative write amount and the cumulative read amount (step S404).

The controller 4 records the determined code rate (step S405).

According to the process of FIG. 16, when the cumulative error count is smaller than a predetermined value and at least one of the cumulative write amount and the cumulative read amount is smaller than the fourth threshold value, the write data can be encoded at the default code rate which is, for example, the code rate smaller than 1, irrespective of the calculated UBER.

As described above, according to the embodiment, the code rate is changed such that the code rate becomes larger when the first value obtained by dividing the cumulative error count by the cumulative write amount or the cumulative read amount is less than the first threshold value. In addition, the code rate is changed such that the code rate becomes smaller when the first value is larger than or equal to the second threshold value that is larger than or equal to the first threshold value. Therefore, since the code rate can be made larger when the memory system 3 is in stable operation, the controller 4 can decrease the frequency at which the erasure recovery code which is unlikely to be used is written to the NAND flash memory 5. This suppresses increase in write amplification in the memory system 3.

In addition, when determining the code rate, the controller 4 can avoid the frequency of occurrence of data errors being underestimated, by using the smaller value of the cumulative write amount and the cumulative read amount, even if the value of either of the cumulative write volume and the cumulative read volume is extremely larger than the other.

Moreover, when the cumulative error count is smaller than a predetermined value and at least one of the cumulative write amount and the cumulative read amount is smaller than the fourth threshold value, the controller 4 encodes a plurality of pieces of write data using the predetermined code rate less than 1, irrespective of the UBER value. This is because, in a short time after the memory system 3 starts operation, the value obtained by dividing the cumulative error count by the smaller value of the cumulative write volume and the cumulative read volume is an unstable value.

While certain embodiments have been described, these embodiments have been presented by way of example only, and are not intended to limit the scope of the inventions. Indeed, the novel devices and methods described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

What is claimed is:

1. A memory system connectable to a host, comprising:
a nonvolatile memory; and
a controller configured to generate a codeword including a plurality of pieces of write data received from the host and to write the codeword to the nonvolatile memory, wherein
the controller is configured to:
when a code rate is less than 1, encode, based on the code rate, the plurality of pieces of write data to generate the codeword including the plurality of pieces of write data and one or more erasure recovery codes;
when the code rate is 1, generate the codeword including the plurality of pieces of write data and not including an erasure recovery code;
calculate a cumulative error count indicative of a cumulative value of the number of times a data error occurs, the data error being an error that fails to return correct data to the host;
calculate at least one of a cumulative write amount or a cumulative read amount, the cumulative write amount being indicative of a total amount of write data written to the nonvolatile memory based on write commands received from the host, the cumulative read amount being indicative of a total amount of read data required to be read from the nonvolatile memory by read commands received from the host;
change the code rate based on a first value which is obtained by dividing the cumulative error count by the cumulative write amount or the cumulative read amount, such that the code rate is increased when the first value is less than a first threshold value, and the code rate is decreased when the first value is larger than or equal to a second threshold value larger than or equal to the first threshold value; and
when the code rate is changed, encode new write data received from the host, and data to be copied from a copy source memory location to a copy destination memory location in the nonvolatile memory, using the changed code rate.

2. The memory system of claim 1, wherein
the number of times the data error occurs is the number of times an unrecoverable error occurs, and
the unrecoverable error is an error which cannot be recovered by an erasure recovery process using the one or more erasure recovery codes.

3. The memory system of claim 1, wherein
the nonvolatile memory includes a plurality of blocks, each of the plurality of blocks being a unit for a data erase operation, and
the controller is further configured to:
write the codeword across a plurality of first blocks among the plurality of blocks such that the plurality of pieces of write data and zero or more erasure recovery codes are written to different blocks of the nonvolatile memory.

4. The memory system of claim 3, wherein
the codeword is a systematic code including the one or more erasure recovery codes as redundant codes,
the codeword is capable of recovering a same amount of lost data as an amount of the redundant codes included in the codeword,
the controller is further configured to:
when writing the codeword across the plurality of first blocks, generate first information, the first information including (i) an identifier of each of the plurality of first blocks, (ii) an information indicative of the number of the plurality of first blocks, and (iii) an information indicative of the number of blocks, of the plurality of first blocks, to which the redundant codes are written; and
when loss of data included in the codeword is detected and an amount of the lost data does not exceed an amount of the redundant codes determined based on the number of blocks to which the redundant codes are written, recover the lost data using (i) pieces of remaining data included in the codeword, excluding the lost data, and (ii) the redundant codes included in the codeword, and
each of the plurality of first blocks stores only data included in each of a plurality of codewords or only a redundant code included in each of the plurality of codewords.

5. The memory system of claim 3, wherein
the controller is further configured to:
manage an erase count of each of the plurality of blocks; and
execute wear leveling of reducing a difference in the erase count between the plurality of blocks.

6. The memory system of claim 1, wherein
the controller is further configured to:
decrease an amount of erasure recovery codes to be included in the codeword to increase the code rate.

7. The memory system of claim 1, wherein
the controller is further configured to:
when the cumulative error count is smaller than a third threshold value and at least one of the cumulative write amount and the cumulative read amount is smaller than a fourth threshold value, encode the plurality of pieces of write data using a first code rate less than 1, irrespective of the first value.

8. The memory system of claim 1, wherein
the first value is calculated by dividing the cumulative error count by a smaller value of the cumulative write amount and the cumulative read amount.

9. The memory system of claim 1, wherein
when the code rate is changed, a codeword generated using the code rate before the change and already written to the nonvolatile memory is retained in the nonvolatile memory.

10. A control method of controlling a nonvolatile memory, comprising:
when a code rate is less than 1, encoding, based on the code rate, a plurality of pieces of write data received from a host to generate a codeword including the plurality of pieces of write data and one or more erasure recovery codes, and writing the codeword to the nonvolatile memory;
when the code rate is 1, generating a codeword including the plurality of pieces of write data and not including an erasure recovery codes, and writing the codeword to the nonvolatile memory;
calculating a cumulative error count indicative of a cumulative value of the number of times a data error occurs, the data error being an error that fails to return correct data to the host;
calculating at least one of a cumulative write amount or a cumulative read amount, the cumulative write amount being indicative of a total amount of write data written to the nonvolatile memory based on write commands received from the host, the cumulative read amount being indicative of a total amount of read data required to be read from the nonvolatile memory by each of read commands received from the host;
changing the code rate based on a first value which is obtained by dividing the cumulative error count by the cumulative write amount or the cumulative read amount, such that the code rate is increased when the first value is less than a first threshold value, and the code rate is decreased when the first value is larger than or equal to a second threshold value larger than or equal to the first threshold value; and
when the code rate is changed, encoding new write data received from the host, and data to be copied from a copy source memory location to a copy destination memory location in the nonvolatile memory, using the changed code rate.

11. The control method of claim 10, wherein
the number of times the data error occurs is the number of times an unrecoverable error occurs, and
the unrecoverable error is an error which can not be recovered by an erasure recovery process using the one or more erasure recovery codes.

12. The control method of claim 10, wherein
the nonvolatile memory includes a plurality of blocks, each of the plurality of blocks being a unit for a data erase operation, and
the writing the codeword includes writing the codeword across a plurality of first blocks among the plurality of blocks such that the plurality of pieces of write data and zero or more erasure recovery codes are written to different blocks of the nonvolatile memory.

13. The control method of claim 12, wherein
the codeword is a systematic code including the one or more erasure recovery codes as redundant codes,
the codeword is capable of recovering a same amount of lost data as an amount of the redundant codes included in the codeword,
the method further comprises:
when writing the codeword across the plurality of first blocks, generating first information, the first information including (i) an identifier of each of the plurality of first blocks, (ii) an information indicative of the number of the plurality of first blocks, and (iii) an information indicative of the number of blocks, of the plurality of first blocks, to which the redundant codes are written; and
when loss of data included in the codeword is detected and an amount of the lost data does not exceed an amount of the redundant codes determined based on the number of blocks to which the redundant codes are written, recovering the lost data using (i) pieces of remaining data included in the codeword, excluding the lost data, and (ii) the redundant codes included in the codeword, and
each of the plurality of first blocks stores only data included in each of a plurality of codewords or only a redundant code included in each of the plurality of codewords.

14. The control method of claim 12, further comprising:
managing an erase count of each of the plurality of blocks; and
executing wear leveling of reducing a difference in the erase count between the plurality of blocks.

15. The control method of claim 10, wherein
the increasing the code rate includes decreasing an amount of erasure recovery codes to be included in the codeword to increase the code rate.

16. The control method of claim 10, further comprising:
when the cumulative error count is smaller than a third threshold value and at least one of the cumulative write amount and the cumulative read amount is smaller than a fourth threshold value, encoding the plurality of pieces of write data using a first code rate less than 1, irrespective of the first value.
